(19) United States
(12) Patent Application Publication
(10) Pub. No.: US 2008/0029381 A1
(43) Pub. Date: Feb. 7, 2008

(54) Distillation Installation Comprising Columns With Corrugated-Crossed Structured Packings And Method Of Increasing The Capacity Of A Distillation Installation

(76) Inventors: Richard Dubettier, La Varenne Saint Hilaire (FR); Frederic Judas, Chatenary-Malabry (FR)

Correspondence Address: AIR LIQUIDE;Intellectual Property, 2700 POST OAK BOULEVARD, SUITE 1800, HOUSTON, TX, 77056, US

(21) Appl. No.: 10/556,622

(22) PCT Filed: Apr. 30, 2004
(86) PCT No.: PCT/FR04/01052

§ 371 Date: Mar. 5, 2007

(30) Foreign Application Priority Data
May 9, 2003 (FR) 03/50150

(51) Int. Cl. B01J 19/32

(52) U.S. Cl. 203/41; 202/158

(57) ABSTRACT

The invention relates to a distillation installation comprising a system of columns (1, 3) and means for conveying a flow (7, 9) that is to be separated into one column (1) in said system. According to the invention, at least one segment (A, D) of one column contains structured packings comprising packs having a non-modified interface if, in the operating segment, the rate ratio is below a rate ratio threshold, said rate ratio being the ratio between the real reflux rate and the minimum reflux rate of the segment, and/or the charge ratio is above a charge ratio threshold, said charge ratio being the ratio between a falling flow of liquid and the section of the segment. Moreover, at least one segment (C, G) of a column, which is designed to operate with a rate ratio above the rate ratio threshold and/or with a charge ratio below the charge ratio threshold, contains structured packings comprising packs having at least one modified interface.

The present invention relates to a distillation installation comprising columns with cross-corrugated structured packings and to a method of increasing the capacity of a distillation installation. Preferably, this is an installation for cryogenic distillation.

It is known to use structured packings in a cryogenic distillation installation either for separating air gases or for separating mixtures containing hydrogen and carbon monoxide (EP-A-837 031).

Cross-corrugated packings consist of modules called “packs”, each of which is formed from a stack of corrugated strips in an oblique arrangement, alternately in one direction and the other. These strips may or may not be perforated and made from smooth or textured sheet, generally metal sheet. Examples are described in GB-A-1 004 046 and in CA-A-1 095 827.

In the case of distillation columns, the strips lie in generally vertical planes. The packs are generally rotated through 90° about the axis of the column from one pack to the next, and it has been shown that these changes in direction cause, at the interfaces between the packs, flooding that limits the load that can be treated by the column.

Various means have been proposed for limiting this flooding. In particular, WO-A-97/16247 discloses a corrugation in which the generatrices are curved at each end so as to become vertical at the upper and lower edges of the pack.

Other ways of modifying the corrugations so that the resistance is reduced at the lower edge and possibly the upper edge of the module are disclosed in patent EP-A-0 707 885. For example, the bottom part of the pack may contain more perforations than the central part, the corrugations may be of reduced height in the bottom part of the pack compared with the height of the corrugations in a central region, or the lower end of the pack may contain cuts.

These packings with a modified interface are much more sensitive to any maldistribution than the conventional packings having an unmodified interface. In addition, when the liquid load of a pack increases, the gain in capacity of certain packings with a modified interface decreases. Loss of efficiency may also be observed with a high liquid load, because of entrainment of one phase by another.

In the case of columns designed on the basis of low pressure drop criteria (such as argon columns, which are typically designed with a maximum pressure drop of 2 mbar/m), the gain provided by packings with a modified interface (typically 10% of the cᵥ) is considerably reduced compared with the possible gain with flooding (30% of the cᵥ).

In this type of column, the gain provided by modifying the interfaces is small, and the risk of maldistribution is high.

A pack with an unmodified interface is a pack of cross-corrugated structured packings having corrugations with substantially the same geometry over the entire height of the pack, with no cuts at the lower end.

A pack with a modified interface is a pack of cross-corrugated structured packings having corrugations with a central region on the inside of the pack, constituting at least 50% of the height of the pack, and a lower region going down to the lower end of the pack, the pack being modified in the lower region compared with the central region so that the resistance to the flow of gas is reduced compared with that of the gas in the central region.

A pack with modified interfaces is a pack with cross-corrugated structured packings having corrugations with a central region on the inside of the pack, constituting at least 50% of the height of the pack, a lower region going down to the lower end of the pack, and an upper region going up to the upper end of the pack, the pack being modified in the lower and upper regions compared with the central region in such a way that the resistance to the flow of a gas is reduced therein compared with that of the gas in the central region.

The packings mentioned in the above document preferably have a specific surface area ranging from 250 m²/m³ to 900 m²/m³. According to a preferred embodiment, these are perforated packings with a smooth surface.

Preferably, the pack with a modified interface is a pack as described above but also including an upper region going up to the upper end of the pack, the pack being modified in the upper region compared with the central region in such a way that the resistance to the flow of a gas is reduced therein compared with that of the gas in the central region.

All the resistance reduction means disclosed in EP-A-0 707 885 can be envisaged.

Preferably, the corrugations have a modified geometry in the lower region (and possibly in the upper region) so that the generatrices of the corrugations are curved at one (each) end, becoming vertical at the lower edge (and upper edge) of the pack. Of course, the lower region may at the same time include other modifications capable of reducing the resistance to gas flow therein.

It is an object of the present invention to provide a separation installation that alleviates the drawbacks of the known installations and that, in particular, avails itself of the advantages of packings with a modified interface, while still reducing the negative effects thereof by judiciously splitting up the packings with a modified interface and packings without a modified interface.

One aspect of the invention provides a distillation installation, optionally for cryogenic distillation, comprising a column system and means for sending a stream to be separated, which is optionally cooled and purified, into a column of the column system, at least one packing portion of a column, designed to operate, when in use:
(i) with a rate ratio below a rate ratio threshold, this rate ratio being the ratio of its actual reflux rate to the minimum reflux rate of the packing portion and/or
(ii) with a load ratio above a load ratio threshold, this load ratio being the ratio of a descending liquid flow rate to the cross section of the packing portion,
   containing structured packings, the pack(s) of which has (have) an unmodified interface, which installation is characterized in that at least one packing portion of a column designed to operate, when in use, with a rate ratio above the rate ratio threshold and/or with a load ratio below a load ratio threshold contains structured packings, the pack(s) of which has (have) at least one modified interface.

For example, the rate ratio threshold could be 1.05 and the load ratio threshold could be 400 l/h/dm². Of course, other values may be envisaged.

Preferably, the packing portions of a column that are designed to operate, when in use, with a reflux rate ratio below the rate ratio threshold and/or with a load ratio above the load ratio threshold contain structured packings, the pack(s) of which has (have) an unmodified interface and the packing portions of a column that are designed to operate, when in use, with a reflux rate ratio above the rate ratio threshold and/or with a load ratio below the load ratio threshold contain structured packings, the packs of which have at least one modified interface.

The installation may be a cryogenic air distillation installation comprising a medium-pressure column and a low-pressure column that are thermally coupled to each other, optionally one column operating at an intermediate pressure between the medium and low pressures, and means for feeding this column from the medium-pressure column, means for sending air at least to the medium-pressure column, in which installation, in respect of the medium-pressure column and/or the low-pressure column and optionally the intermediate- pressure column, at least one lower packing portion of the column contains a pack with an unmodified interface and at least one upper packing portion contains a pack with a modified interface.

The installation may be a cryogenic air distillation installation comprising a medium-pressure column and a low-pressure column that are thermally coupled to each other, an argon column, means for sending air to at least the medium-pressure column and means for sending an argon-enriched gas coming from the low-pressure column to the argon column, in which installation at least one of the packing portions of the argon column, preferably all the packing portions of the argon column contain one or more packs with an unmodified interface, whereas at least one packing portion of the low-pressure column or of the medium-pressure column contains a pack with a modified interface.

The installation may be a cryogenic distillation installation comprising a medium-pressure column and a low-pressure column that are thermally coupled to each other, a mixing column, means for sending air to at least the medium-pressure column and means for sending an oxygen-enriched liquid, coming from the low-pressure column, and air to the mixing column, in which installation at least one of the packing portions of the mixing column, preferably all the packing portions of the mixing column, contain a pack with an unmodified interface, whereas at least one packing portion of the low-pressure column or of the medium-pressure column contains a pack with a modified interface.

The installation may be a cryogenic distillation installation for distilling a mixture comprising mainly carbon monoxide and/or hydrogen and/or nitrogen and/or methane comprising a methane washing column and/or a nitrogen washing column and/or a distillation column and/or a stripping column. This type of installation may include a methane washing column, a stripping column, means for sending the mixture to the methane washing column and means for sending a liquid from the lower part of the methane washing column to the upper part of the stripping column, in which installation the stripping column contains, at least one pack with an unmodified interface and the washing column contains at least one pack with one or more modified interfaces.

Preferably, at least one packing portion of a column is designed to operate, when in use:
i) with a rate ratio below a rate ratio threshold, this rate ratio being the ratio of its actual reflux rate to the minimum reflux rate of the packing portion and/or
ii) with a load ratio above a load ratio threshold, this load ratio being the ratio of a descending liquid flow rate to the cross section of the packing portion, contains only structured packings, the pack(s) of which has (have) an unmodified interface and at least one packing portion of a column designed to operate, when in use, with a rate ratio above the rate ratio threshold and/or with a load ratio below a load ratio threshold contains only structured packings, the pack(s) of which has (have) at least one modified interface.

Another aspect of the invention provides a distillation process, optionally for cryogenic distillation, in a unit comprising a column system comprising the steps of:
a) sending a cooled and purified stream to be separated into a column of the column system;
b) separating the stream in the column system in order to form fluids enriched with at least one component of the mixture, at least one packing portion of a column operating:
   i) with a rate ratio below a rate ratio threshold, this rate ratio being the ratio of its actual reflux rate to the minimum reflux rate of the packing portion and/or
   ii) with a load ratio above a load ratio threshold, this load ratio being the ratio of a descending liquid flow rate to the cross section of the packing portion,
      and containing structured packings, the pack(s) of which have an unmodified interface and characterized in that at least one packing portion of a column operates with a rate ratio above the rate ratio threshold and/or with a load ratio below a load ratio threshold and contains structured packings, the pack(s) of which has (have) at least one modified interface.

Another aspect of the invention provides a method of increasing the capacity of at least one column of a distillation installation, optionally for cryogenic distillation, comprising a column system that contains only packs having an unmodified interface or trays, by replacing certain packs or trays with packs having one or more modified interfaces, comprising the step of installing packs with one or more modified interfaces in at least some of the packing portions, and preferably only those packing portions, which are designed to operate with a rate ratio above a rate ratio threshold, this rate ratio being the ratio of its actual reflux rate to the minimum reflux rate of the packing portion, and/or with a load ratio below a load ratio threshold, this load ratio being the ratio of a descending liquid flow rate to the cross section of the packing portion.

Preferably, packs having one or more modified interfaces are not installed in at least some, preferably all, of the packing portions designed to operate with a rate ratio below a rate ratio threshold, this rate ratio being the ratio of its actual reflux rate to the minimum reflux rate of the packing portion, and/or with a load ratio above the load ratio threshold, this load ratio being the ratio of a descending liquid flow rate to the cross section of the packing portion.

For example, at most packs of packings in the upper part of a column (the part most loaded with gas), preferably only the top packing portion, are replaced with one or more packs having one or more modified interfaces and the packs having unmodified interfaces are left in the lower part of the column.

The invention will be described in greater detail with reference to the figures:

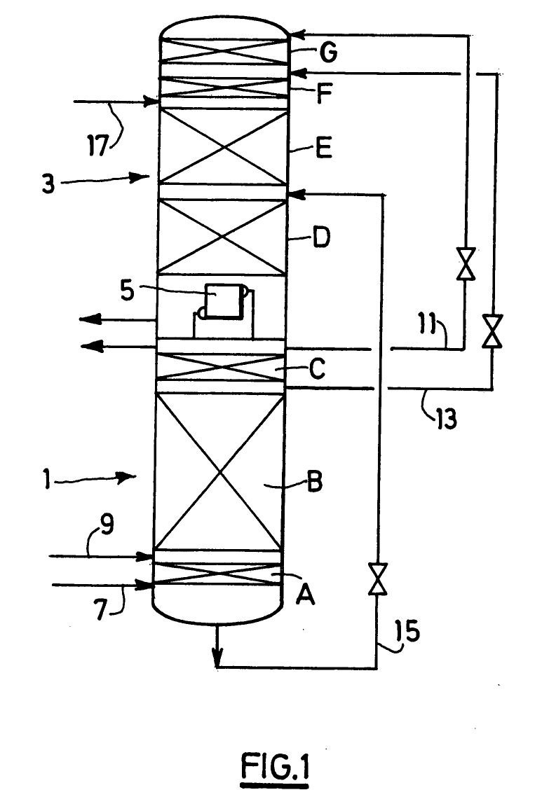

FIG. 1 shows a cryogenic distillation air separation unit comprising a medium-pressure column and a low-pressure column;

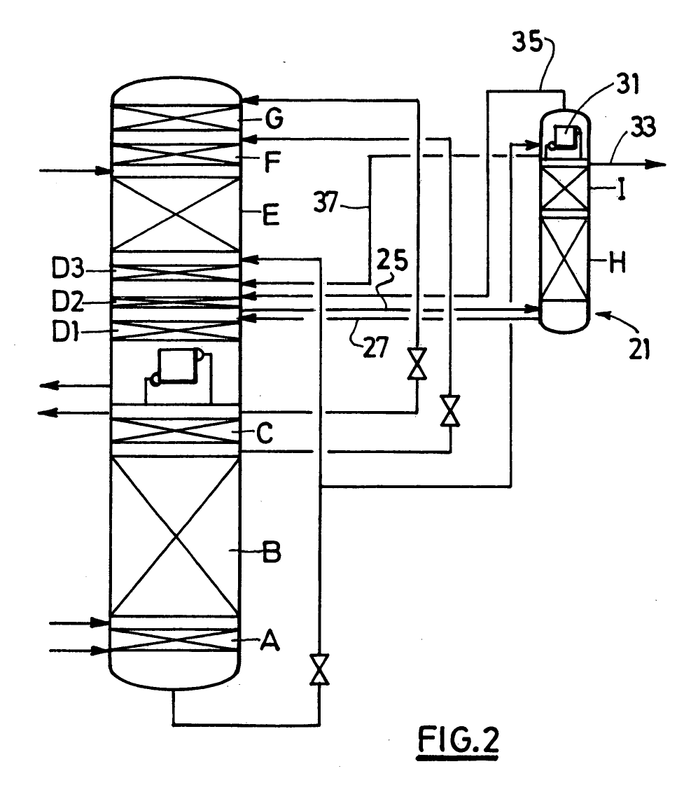

FIG. 2 shows a cryogenic distillation air separation unit comprising a medium-pressure column, a low-pressure column and an argon column;

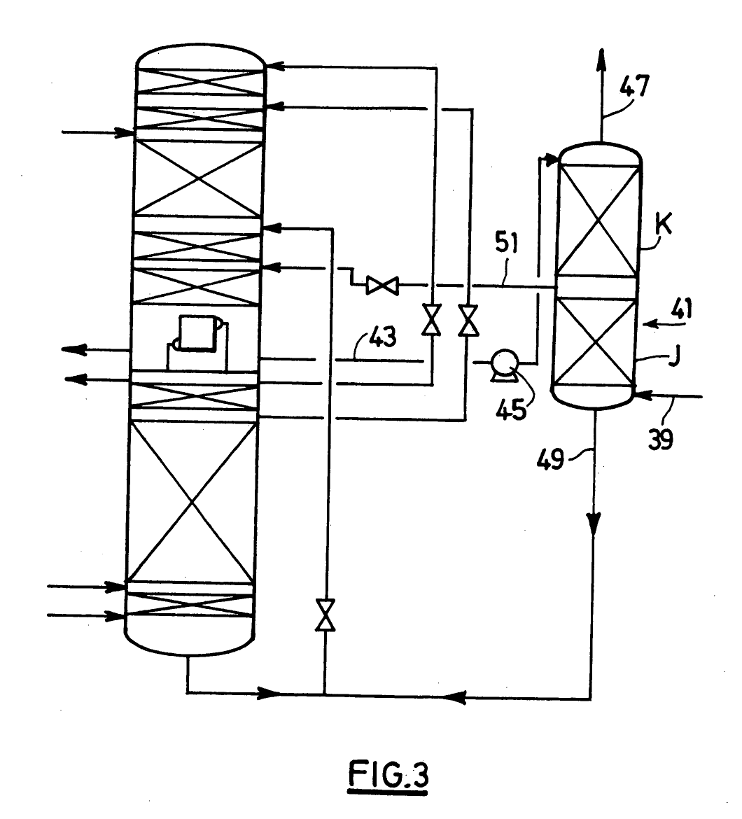

FIG. 3 shows a cryogenic distillation air separation apparatus comprising a medium-pressure column, a low-pressure column and a mixing column;

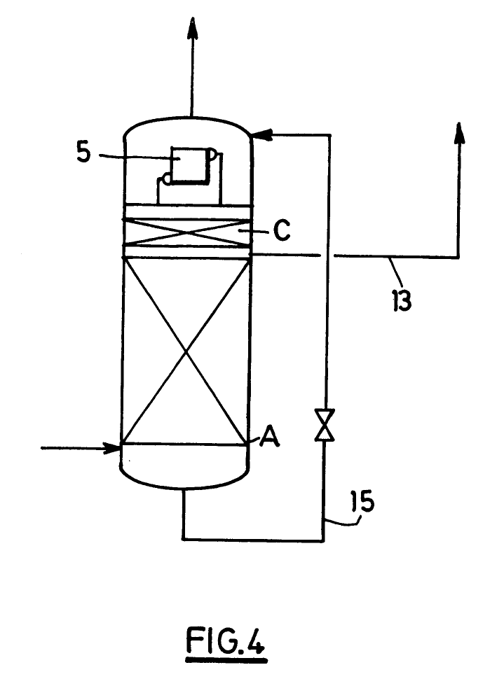

FIG. 4 shows a cryogenic distillation air separation unit comprising a single column; and

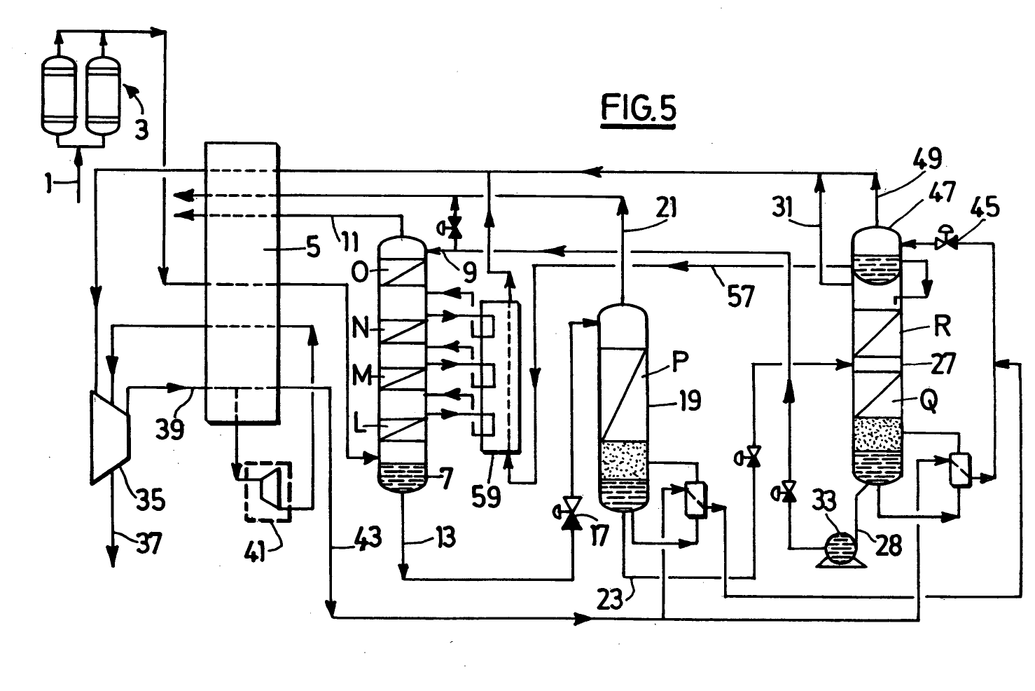

FIG. 5 shows a separation unit for separating a mixture comprising hydrogen, carbon monoxide, methane and possibly nitrogen as main constituents.

FIG. 1 shows a medium-pressure column 1 thermally coupled to a low-pressure column 3 by means of a condenser/reboiler 5, which condenses the overhead nitrogen of the medium-pressure column and returns condensed nitrogen as reflux thereto.

Gaseous air 7 is sent into the bottom of the medium-pressure column 1, as is also liquid air 9. Between the two air intakes there is a packing portion A.

Streams of liquid nitrogen of various purities are withdrawn from the top of the medium-pressure column. The stream 11 coming from the top of the column is sent, to the top of the low-pressure column, and the stream 13 is sent from an intermediate level of the medium-pressure column to an intermediate level of the low-pressure column 3.

The liquid air intake 9 and the liquid nitrogen offtake 13 are separated by a packing portion B and the liquid nitrogen offtakes 13 and 11 are separated by a packing portion C.

A rich liquid stream 15 is sent from the bottom of the medium-pressure column 1 to an intermediate level of the low-pressure column 3 and a packing portion D separates the bottom of the low-pressure column from the rich-liquid intake level.

A second liquid air stream 17 is sent to the low-pressure column. A packing portion E separates the rich-liquid intake 15 from the liquid air intake 17. A packing portion F separates the air intake 17 from the liquid nitrogen intake 13 and a packing portion G separates the liquid nitrogen intakes 11 and 13.

It will be understood that sending liquid nitrogen 13 to the top of the column is optional and therefore the packing portions F and G (and B and C respectively) may constitute a single packing portion. Likewise, the liquid air intake 17 is optional and therefore the packing portions E and F may constitute a single packing portion, and the liquid air intake 9 is optional and therefore the packing portions A and B may constitute a single packing portion.

However, a gaseous air stream coming from a blowing turbine may replace the liquid air intake 17.

According to the invention, in the medium-pressure column, the packing portion A contains packings having an unmodified interface and the packing portions B and C contain packings having a modified interface. Alternatively, the medium-pressure column may contain only trays.

According to the invention, in the low-pressure column the packing portion D contains packings having an unmodified interface and the packing portions E, F and G contain packings having a modified interface.

FIG. 2 shows a double column, which differs from that of FIG. 1 in that the low-pressure column is connected to an argon column. Consequently, the packing portion D is split, to form three packing portions D1, D2 and D3.

The packing portion D1 separates the bottom of the low-pressure column from the offtake of argon-enriched gas 25, intended for the argon column 21, and also the intake 27 of bottoms liquid, coming from the argon column.

Above the packing portion D1 is the packing portion D2.

Part of the rich liquid is sent to the overhead condenser 31 of the argon column 21, where it partially vaporizes producing a stream 35 of vaporized rich liquid and a stream 37 of unvaporized rich liquid, the two streams being sent into the low-pressure column at the space between the packing portion D2 and the packing portion D3.

The remainder of the rich liquid is sent above the packing portion D3.

At least the packing portion D1 contains only packs without modified interfaces. Preferably, the packing portion D2 contains only packs without modified interfaces and even more preferably the packing portion D3 contains only packs without modified interfaces.

The packing portions E, F and G contain only packs with modified interfaces.

In the argon column itself, there are two packing portions H and I, the argon-rich stream being withdrawn above the packing portion I. The two packing portions H and I contain only packs having one or more unmodified interfaces. Alternatively, the packing portion H may contain packs having an unmodified interface and the packing portion I contains packs having one or more modified interfaces.

FIG. 3 differs from FIG. 1 in that it includes a mixing column 41. This column, fed into the bottom with a stream of air 39 and into the top with liquid oxygen 43 pumped in a pump 45, contains two packing portions J and K. Gaseous oxygen 47 is produced as overhead of the column 41. The bottoms liquid 49 is mixed with the rich liquid and sent to the low-pressure column. A stream 51 of very rich liquid is withdrawn from between the packing portions J and K, expanded and sent to the low-pressure column.

The packing portion K (the one most loaded with liquid) and optionally the packing portion J contain packs having an unmodified interface, whereas at least some of the packing portions of the double column contain packs with a modified interface. Preferably, the type of packing used for the double column is as described for FIG. 1, namely for the medium-pressure column, the packing portion A contains packings with an unmodified interface and the packing portions B and C contain packings with one or more modified interfaces, while for the low-pressure column the packing portion D contains packings having an unmodified interface and the packing portions E, F and G contain only packs with one or more modified interfaces. Alternatively, the medium-pressure column may contain only trays.

FIG. 4 shows a single-column air separation installation. The single column 1 is fed with a stream 7 of gaseous air. A rich liquid stream 15 is withdrawn as bottoms from the column and sent to the overhead condenser/reboiler 5 where it vaporizes. The overhead nitrogen partly condenses in the condenser/reboiler 5. A stream of gaseous nitrogen 13 is withdrawn a few trays below the top of the column as product. The column contains two packing portions, A below the withdrawal of gaseous nitrogen 13 and C above this withdrawal. The packing portion A contains at least one pack, the pack or packs being packs of packings having one or more modified interfaces, whereas the packing portion C contains at least one pack, the pack or packs having an unmodified interface.

FIG. 5 shows a three-column installation for separating a mixture of hydrogen, carbon monoxide and methane. This mixture 1 is purified at 3, cooled in an exchanger 5 and sent into a methane washing column 7. The bottoms liquid 13 from this washing column is expanded and sent to the top of a stripping column 19. The bottoms liquid 23 from the stripping column is then separated in a distillation column 27 into a gas 31 rich in carbon monoxide and a liquid 28 rich in methane, at least some of which is recycled into the washing column 7. The installation is kept cold by a carbon monoxide cycle that warms the sumps of the columns 19, 27 and cools the top of the column 27, which cycle comprises a compressor 35, used also to compress the product 37, and a turbine 41.

The washing column 7 contains packs L, M, N and O having one or more modified interfaces and the distillation column 29 contains two packs Q, R having one or more modified interfaces. However, the stripping column 19 contains only a pack P having an unmodified interface.

When, in the case of a double air separation column as shown in FIG. 1 and 2, it is desired to modify a column having trays or a column having packs with unmodified interfaces, packs of packings having modified interfaces are installed, preferably in the packing portions F, G.

1-11. (canceled)

12. A distillation installation, optionally for cryogenic distillation, comprising a column system (1, 3, 7, 19, 21, 27, 41) and means for sending a stream to be separated, which is optionally cooled and purified, into a column of the column system, at least one packing portion (A, D, D1, D2, D3, H, I, J, K, P) of a column, designed to operate, when in use:
(i) with a rate ratio below a rate ratio threshold, this rate ratio being the ratio of its actual reflux rate to the minimum reflux rate of the packing portion; and/or
(ii) with a load ratio above a load ratio threshold, this load ratio being the ratio of a descending liquid flow rate to the cross section of the packing portion, containing structured packings, the pack(s) of which has (have) an unmodified interface, which installation is characterized in that at least one packing portion (B, C, E, F, G, I, J, L, M, N, O, Q, R) of a column designed to operate, when in use, with a rate ratio above the rate ratio threshold and/or with a load ratio below a load ratio threshold contains structured packings, the pack(s) of which has (have) at least one modified interface, the rate ratio threshold being 1.05 and the load ratio threshold being 400 l/h/dm².

13. The installation as claimed in claim 12, in which the packing portions of a column that are designed to operate, when in use, with a reflux rate ratio below the rate ratio threshold and/or with a load ratio above the load ratio threshold contain structured packings, the pack(s) of which has (have) an unmodified interface and the packing portions of a column that are designed to operate, when in use, with a reflux rate ratio above the rate ratio threshold and/or with a load ratio below the load ratio threshold contain structured packings, the packs of which have at least one modified interface.

14. The cryogenic air distillation installation as claimed in claim 12, comprising a medium-pressure column (1) and a low-pressure column (3) that are thermally coupled to each other, optionally one column operating at an intermediate pressure between the medium and low pressures, and means for feeding this column from the medium-pressure column, means for sending air at least to the medium-pressure column, in which installation, in respect of the medium-pressure column and/or the low-pressure column and optionally the intermediate-pressure column, at least one lower packing portion of the column contains a pack with an unmodified interface and at least one upper packing portion contains a pack with a modified interface.

15. The cryogenic air distillation installation as claimed in claim 12, comprising a medium-pressure column (1) and a low-pressure column (3) that are thermally coupled to each other, an argon column (21), means for sending air to at least the medium-pressure column and means for sending an argon-enriched gas coming from the low-pressure column to the argon column, in which installation at least one of the packing portions of the argon column, preferably all the packing portions of the argon column contain one or more packs with an unmodified interface, whereas at least one packing portion of the low-pressure column or of the medium-pressure column contains a pack with a modified interface.

16. The cryogenic air distillation installation as claimed in claim 12, comprising a medium-pressure column (1) and a low-pressure column (3) that are thermally coupled to each other, a mixing column (41), means for sending air to at least the medium-pressure column and means for sending an oxygen-enriched liquid, coming from the low-pressure column, and air to the mixing column, in which installation at least one of the packing portions of the mixing column, preferably all the packing portions of the mixing column, contain a pack with an unmodified interface, whereas at least one packing portion of the low-pressure column or of the medium-pressure column contains a pack with a modified interface.

17. The cryogenic distillation installation as claimed in claim 12 for distilling a mixture comprising mainly carbon monoxide and/or hydrogen and/or nitrogen and/or methane, comprising a methane washing column (7) and/or a nitrogen washing column and/or a distillation column (27) and/or a stripping column (19).

18. The installation as claimed in claim 17, comprising a methane washing column (7), a stripping column (19), means for sending the mixture to the methane washing column and means for sending a liquid from the lower part of the methane washing column to the upper part of the stripping column, in which installation the stripping column contains at least one pack with an unmodified interface and the washing column contains at least one pack with one or more modified interfaces.

19. The installation as claimed in claim 12, in which at least one packing portion of a column designed to operate, when in use:
i) with a rate ratio below a rate ratio threshold, this rate ratio being the ratio of its actual reflux rate to the minimum reflux rate of the packing portion; and/or
ii) with a load ratio above a load ratio threshold, this load ratio being the ratio of a descending liquid flow rate to the cross section of the packing portion, contains only structured packings, the pack(s) of which has (have) an unmodified interface and at least one packing portion of a column designed to operate, when in use, with a rate ratio above the rate ratio threshold and/or with a load ratio below a load ratio threshold contains only structured packings, the pack(s) of which has (have) at least one modified interface.

20. A distillation process, optionally for cryogenic distillation, in a unit comprising a column system (1, 3, 7, 19, 21, 27, 41) comprising the steps of:
a) sending a cooled and purified stream to be separated into a column of the column system; and
b) separating the stream in the column system in order to form fluids enriched with at least one component of the mixture, at least one packing portion (A, D, D1, D2, D3, H, I, J, K, P) of a column operating:
i) with a rate ratio below a rate ratio threshold, this rate ratio being the ratio of its actual reflux rate to the minimum reflux rate of the packing portion and/or
ii) with a load ratio above a load ratio threshold, this load ratio being the ratio of a descending liquid flow rate to the cross section of the packing portion,
and containing structured packings, the pack(s) of which have an unmodified interface and characterized in that at least one packing portion of a column operates with a rate ratio above the rate ratio threshold and/or with a load ratio below a load ratio threshold and contains structured packings, the pack(s) of which has (have) at least one modified interface, the rate ratio threshold being 1.05 and the load ratio threshold being 400 l/h/dm².

21. A method of increasing the capacity of at least one column (1, 3, 7, 19, 21, 27, 41) of a distillation installation, optionally for cryogenic distillation, comprising a column system that contains only packs having an unmodified interface or trays, by replacing certain packs or trays with packs having one or more modified interfaces, comprising the step of installing packs with one or more modified interfaces in at least some of the packing portions (B, C, E, F, G, I, J, L, M, N, O, Q, R), and preferably only those packing portions, which are designed to operate with a rate ratio above a rate ratio threshold, this rate ratio being the ratio of its actual reflux rate to the minimum reflux rate of the packing portion, and/or with a load ratio below a load ratio threshold, this load ratio being the ratio of a descending liquid flow rate to the cross section of the packing portion, the rate ratio threshold being 1.05 and the load ratio threshold being 400 l/h/dm².

22. The capacity-increasing method as claimed in claim 21, consisting in replacing at most packs of packings in the upper part of a column (the part most loaded with gas), preferably only the top packing portion(s) (F, G), with one or more packs having one or more modified interfaces and in leaving the packs with an unmodified interface in the lower part of the column.
